(19) United States
(12) Patent Application Publication
(10) Pub. No.: US 2025/0350842 A1
(43) Pub. Date: Nov. 13, 2025

(54) CONTROL APPARATUS, CONTROL METHOD, AND STORAGE MEDIUM

(71) Applicant: CANON KABUSHIKI KAISHA, Tokyo (JP)

(72) Inventor: MASAKI KAMBA, Tokyo (JP)

(21) Appl. No.: 19/197,814

(22) Filed: May 2, 2025

(30) Foreign Application Priority Data
May 9, 2024 (JP) 2024-076480

(51) Int. Cl. H04N 23/695

(52) U.S. Cl. CPC H04N 23/695

(57) ABSTRACT

A control apparatus controls an image capturing unit that drives a pan driving unit, a tilt driving unit, and a lens driving unit to move between a plurality of preset positions that specify an image capturing range and the plurality of preset positions, and includes a control unit configured to determine control information enabling control so that all the driving units start driving and stop driving simultaneously at a time of moving from a first preset position to a second preset position, and an acquisition unit configured to acquire driving information of each of the driving units, and wherein, in a case where the acquisition unit acquires the driving information at the time of moving from the first preset position to the second preset position, the control unit corrects the control information based on the driving information and controls the image capturing unit based on the corrected control information.

### BACKGROUND

### Field

The present disclosure relates to a technique for controlling an image capturing apparatus.

### Description of the Related Art

Monitoring systems and video distribution systems include pan-tilt-zoom cameras (hereinbelow, also referred to as PTZ cameras) that can drive a pan-tilt driving unit and an image capturing unit in order to change an image capturing range via a network or a dedicated line.

In such PTZ cameras, a preset function of enabling a user to register a plurality of positions of each driving unit as preset positions in advance and a preset tour function or an automatic loop function of controlling each driving unit to capture images of the plurality of preset positions in order are known.

In a case where the above-described preset function is executed in PTZ cameras used for broadcasting services and video production, some of them specify a driving time for driving to a target preset position and control each driving unit to start and stop driving simultaneously based on the specified driving time. In a case where each driving unit drives from a current position to a target position registered as a preset position, controlling each driving unit to start and stop driving simultaneously is referred to as a shot operation. In the patent literature 1, in movement of an image capturing position from a current position to a target position, a movement time from the current position to the target position is specified by a movement instruction of such as pan, tilt, zoom, or focus. In Japanese Patent Application Laid-Open No. 2004-325710, a control method is discussed for calculating an optimum driving speed from the specified movement time and respective movement distances of pan, tilt, zoom, focus, and other moving members to simultaneously drive and stop the respective moving members.

However, if the above-described preset tour and automatic loop are executed and the shot operations are repeated between predetermined preset positions, errors in motor control and communication control may accumulate, and a phenomenon in which the moving members do not start and stop driving at the same time (synchronization deviation) may occur.

### SUMMARY

According to an aspect of the present disclosure, a control apparatus includes at least one memory storing instructions, and at least one processor that, upon execution of the instructions, is configured to operate as: the control apparatus that controls an image capturing unit that drives a pan driving unit, a tilt driving unit, and a lens driving unit so as to move between a plurality of preset positions that specify an image capturing range and the plurality of preset positions, wherein the control apparatus includes a control unit configured to determine control information enabling control so that the pan driving unit, the tilt driving unit, and the lens driving unit start driving and stop driving simultaneously at a time of moving from a first preset position to a second preset position, and an acquisition unit configured to acquire driving information of the pan driving unit, the tilt driving unit, and the lens driving unit at the time of moving from the first preset position to the second preset position, wherein the driving information is information about a driving state of each of the pan driving unit, the tilt driving unit, and the lens driving unit, and wherein, in a case where the acquisition unit acquires the driving information at the time of moving from the first preset position to the second preset position, the control unit corrects the control information based on the driving information and controls the image capturing unit based on the corrected control information.

Further features of the present disclosure will become apparent from the following description of exemplary embodiments with reference to the attached drawings.

### BRIEF DESCRIPTION OF THE DRAWINGS

FIG. 1 is a configuration diagram illustrating an image capturing system according to a first exemplary embodiment.

FIG. 2 is a block diagram illustrating an image capturing apparatus according to the first exemplary embodiment.

FIG. 3 is a block diagram illustrating an external apparatus according to the first exemplary embodiment.

FIG. 4 is an image diagram of controlling a shot operation according to the first exemplary embodiment.

FIG. 5 is an image diagram of synchronization deviation correction tables according to the first exemplary embodiment.

FIG. 6 is a flowchart illustrating a creating method for correction data according to the first exemplary embodiment.

FIG. 7 is a flowchart illustrating a correction method according to the first exemplary embodiment.

FIG. 8 is an image diagram of a control setting screen according to a second exemplary embodiment.

### DESCRIPTION OF THE EMBODIMENTS

Exemplary embodiments of the present disclosure will be described in detail with reference to the attached drawings. The following exemplary embodiments do not restrict the present disclosure according to the claims. A plurality of features is described in the exemplary embodiments, but not all of these features are essential to the present disclosure, and the plurality of features may be arbitrarily combined. The same or similar configurations in the attached drawings are denoted by the same reference numerals, and redundant descriptions will be omitted.

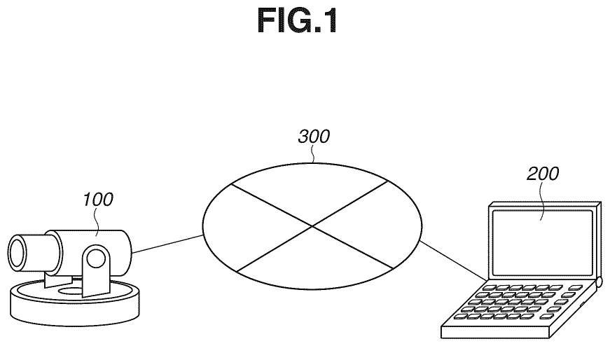

FIG. 1 is a configuration diagram of an image capturing system according to a first exemplary embodiment. The image capturing system according to the present exemplary embodiment includes an image capturing apparatus 100, an external apparatus 200, and a network 300. A connection method between the apparatuses is not limited to a specific method. For example, the apparatuses may be connected to each other by wired cables. The image capturing apparatus 100 receives a command from the external apparatus 200 via the network 300 and transmits a response from a system control unit 101, which is described below, to the external apparatus 200 via the network 300. The image capturing apparatus 100 may actively transmit data to the external apparatus 200 that is connected in advance.

The image capturing apparatus 100 includes a pan driving unit 107 and a tilt driving unit 108, which are described below, and can change an image capturing direction by driving at least one of the pan driving unit 107 and the tilt driving unit 108. The image capturing apparatus 100 can change an imaging angle of view and focus by driving a lens driving unit 104, which is described below.

The image capturing apparatus 100 according to the present exemplary embodiment can drive the pan driving unit 107 to a pan target position, the tilt driving unit 108 to a tilt target position, and the lens driving unit 104 to a lens target position, which are set by the external apparatus 200.

In a case where the image capturing apparatus 100 according to the present exemplary embodiment drives each moving member, such as the above-described lens driving unit 104, pan driving unit 107, and tilt driving unit 108, the image capturing apparatus 100 calculates a control speed so that each moving member reaches each target position at the same time. The image capturing apparatus 100 controls each driving unit according to the calculated control speed (shot operation).

The external apparatus 200 is a general client terminal, such as a personal computer (PC) or a tablet, that includes a display unit such as a display and an operation unit. According to the present exemplary embodiment, a PC in which a monitor and an input device (user interface) are integrated is described as an example, but they may be independent devices.

For example, an input terminal such as a joystick may be connected to the external apparatus 200 via a universal serial bus (USB) or Bluetooth® and used as input for remotely controlling the image capturing apparatus 100.

The external apparatus 200 is described as an apparatus being integrated with hardware including an operation unit for operating a camera, such as a camera controller, but the present disclosure is not limited to this example. If they are independent, the external apparatus 200 uses a control apparatus of the camera controller to perform an operation for setting positions of pan, tilt, and zoom (PTZ) imaging angles of views and other image quality and registering the setting as a preset position. The external apparatus 200 can also call and delete a preset function and perform a detail setting operation for an automatic loop function. In this case, the external apparatus 200 is connected to the image capturing apparatus 100 via the network 300 or using a serial connection or the like.

The network 300 is a network connecting the image capturing apparatus 100 and the external apparatus 200. The network 300 is realized by a plurality of routers, switches, cables, and the like that comply with a communication standard such as Ethernet®. The network 300 may be realized by the internet, a wired local area network (LAN), a wireless LAN, a wide area network (WAN), and the like.

### Description of Each Apparatus

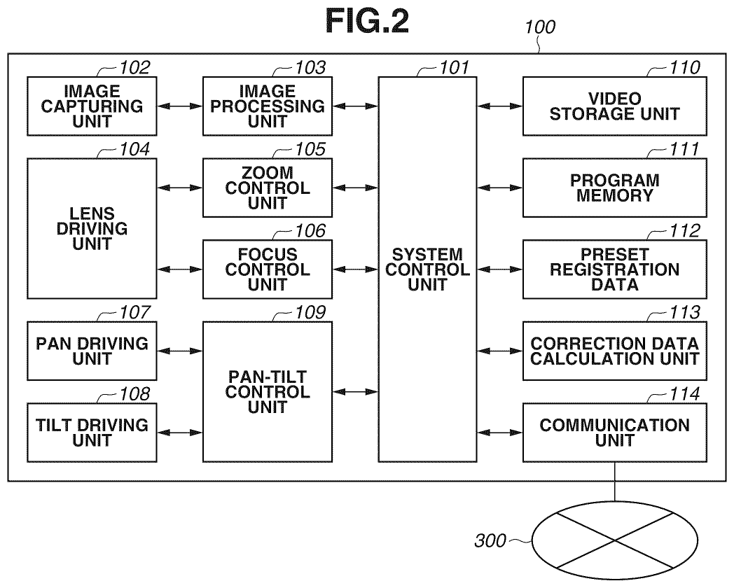

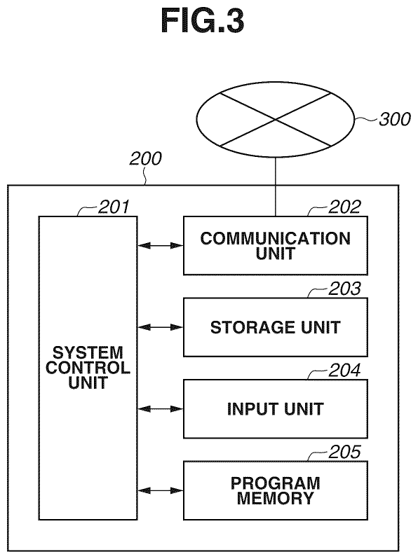

Configuration examples of the image capturing apparatus 100 and the external apparatus 200 according to the present exemplary embodiment are described with reference to FIGS. 2 and 3. The configurations illustrated in FIGS. 2 and 3 are merely examples of the configurations that can realize the present exemplary embodiment, and the present disclosure is not limited to the configurations illustrated in FIGS. 2 and 3.

The configuration in FIG. 2 merely illustrates major components for realizing operations of the image capturing apparatus 100, which are described below. Similarly, the configuration in FIG. 3 merely illustrates major components for realizing operations of the external apparatus 20, which are described below.

For example, configurations that are not major in the following description, such as configurations related to a power supply system and recording and delivering captured video, are not illustrated. As a specific example, processing of at least some components may be realized by hardware incorporated in the image capturing apparatus 100 and the external apparatus 200. As the hardware, for example, a dedicated circuit (application specific integrated circuit (ASIC)) and a processor (digital signal processor (DSP)) can be applied.

FIG. 2 is an example of a block diagram illustrating the image capturing apparatus 100 according to the present exemplary embodiment, and each configuration and function are described. The image capturing apparatus 100 includes the system control unit 101, an image capturing unit 102, an image processing unit 103, the lens driving unit 104, a zoom control unit 105, a focus control unit 106, the pan driving unit 107, the tilt driving unit 108, and a pan-tilt control unit 109. The image capturing apparatus 100 also includes a video storage unit 110, a program memory 111, preset registration data 112, a correction data calculation unit 113, a communication unit 114, and further an internal bus (not illustrated) that enables each of the units 101 to 114 to communicate with each other.

The system control unit 101 is a control unit that controls an entire program and instructs the units 102 to 111 to perform processing. The system control unit 101 analyzes a control command that is transmitted from the external apparatus 200 and received by the communication unit 114 and performs processing according to the control command. Here, control commands can be broadly classified into a request command that requests acquisition of video data and a setting value and a setting command that requests setting of a setting value. Mainly, the system control unit 101 receives a request command for video data from the external apparatus 200 and delivers the video data generated by the image processing unit 103 via the communication unit 114.

In addition, the system control unit 101 receives from the external apparatus 200 a request command for setting values related to image capturing such as zoom, focus, and pan-tilt of the image capturing apparatus 100. Upon receiving the request command for the setting value, the system control unit 101 reads the setting values respectively from the image processing unit 103, the zoom control unit 105, the focus control unit 106, and the pan-tilt control unit 109 and delivers them to the external apparatus 200 via the communication unit 114. Here, the setting values related to image capturing include not only a current value but also related information such as a range of values that can be set to the camera. Further, in a case where the setting command of the setting value related to image capturing is received, the system control unit 101 commands the image processing unit 103, the zoom control unit 105, the focus control unit 106, and the pan-tilt control unit 109 to perform control based on the respective setting values. The image processing unit 103, the zoom control unit 105, the focus control unit 106, and the pan-tilt control unit 109 control the image capturing unit 102, the lens driving unit 104, the pan driving unit 107, and the tilt driving unit 108 based on the commands. Accordingly, the setting values set by the external apparatus 200 are reflected to the image capturing apparatus 100.

The image capturing unit 102 includes a lens and an image capturing element, captures an image of an object and converts the image into an electrical signal.

The image processing unit 103 performs predetermined image processing, resolution conversion processing, and compression encoding processing on the signal captured and photoelectrically converted by the image capturing unit 102 to generate video data. The video data captured by the image capturing unit 102 is output by the communication unit 114 to the external apparatus 200 via the network 300.

The lens driving unit 104 includes driving systems of a focus lens and a zoom lens and motors of their driving sources and is controlled by the zoom control unit 105 and the focus control unit 106.

The pan driving unit 107 includes a mechanical driving system that performs a pan operation and a motor of a driving source, and as an example, can rotate the image capturing direction (an optical axis of an image capturing lens) by 360 degrees in a pan direction. The pan driving unit 107 includes, for example, an actuator, such as a stepping motor, and an encoder that detects a pan position. An operation of the pan driving unit 107 is controlled by the pan-tilt control unit 109. According to the present exemplary embodiment, it is described that the pan driving unit 107 can rotate the image capturing direction by 360 degrees in the pan direction, but a possible angle of rotation in the pan direction is not limited to this example. For example, the rotation may be performed endlessly.

The tilt driving unit 108 includes a mechanical driving system that performs a tilt operation of the image capturing apparatus and a motor of a driving source, and as an example, can rotate the image capturing direction (the optical axis of the image capturing lens) by up to 180 degrees in a tilt direction perpendicular to the pan direction. The tilt driving unit 108 includes, for example, an actuator, such as a stepping motor, and an encoder that detects a tilt position. An operation of the tilt driving unit 108 is controlled by the pan-tilt control unit 109. According to the present exemplary embodiment, it is described that the tilt driving unit 108 can rotate the image capturing direction in the tilt direction from −45 degrees obliquely forward and downward to +90 degrees upward with the horizontal direction being 0 degrees, but a possible angle of rotation in the tilt direction is not limited to this example. For example, the rotation may be performed endlessly.

The pan-tilt control unit 109 commands the pan driving unit 107 and the tilt driving unit 108 to change pan and tilt based on pan and tilt setting values output from the system control unit 101.

The video storage unit 110 stores video data in an internal storage and an external storage.

The program memory 111 is a memory that stores a camera control program, and the system control unit 101 executes various operations based on the camera control program stored in the program memory 111.

The preset registration data 112 stores a plurality of preset position information and updates corresponding data if a preset registration instruction or a deletion instruction is issued from the external apparatus 200 via the communication unit 114. If a preset call instruction is issued, the system control unit 101 acquires corresponding data from the preset registration data 112. Further, the system control unit 101 executes control on the image processing unit 103, the zoom control unit 105, the focus control unit 106, and the pan-tilt control unit 109 based on the acquired data.

The correction data calculation unit 113 stores data for correcting a control command or a control timing if preset movement is performed between predetermined preset positions, which are described below.

The communication unit 114 delivers video data to the external apparatus 200 via the network 300. The communication unit 114 receives a camera control command transmitted from the external apparatus 200 and outputs it to the system control unit 101. The communication unit 114 delivers a response to the external apparatus 200 in accordance with an instruction from the system control unit 101. The camera control command transmitted from the external apparatus 200 mainly includes a request command for video data, a request command for a setting value related to zoom, focus, pan-tilt, and image capturing and image processing of the image capturing apparatus 100, and a setting command.

An example of a block diagram of the external apparatus 200 according to the present exemplary embodiment is illustrated with reference to FIG. 3, and a configuration and a function of each unit are described.

The external apparatus 200 is an apparatus that controls the image capturing apparatus 100. In FIG. 3, the external apparatus 200 includes a system control unit 201, a communication unit 202, a storage unit 203, an input unit 204, and a program memory 205.

The system control unit 201 is a control unit that controls an entire program and instructs the units 202 to 205 to perform processing. The system control unit 201 generates a camera control command in response to a user operation from the input unit 204 or a graphical user interface (GUI) operation and transmits it to the image capturing apparatus 100 via the communication unit 202. By transmitting the camera control command to the image capturing apparatus 100, it is possible to remotely control the image capturing apparatus 100 such as issuing a PTS instruction. In a case where the communication unit 202 receives a response from the image capturing apparatus 100, the system control unit 201 analyzes the response and performs processing according to the response.

The communication unit 202 transmits the camera control command and receives various data delivered from the image capturing apparatus 100. The camera control command includes the request command for the setting value related to zoom, focus, pan-tilt, and image capturing and image processing of the image capturing apparatus 100 and the setting command.

The storage unit 203 stores camera connection information and the like in the internal storage and the external storage. A system may be configured so that the preset registration data 112 of the image capturing apparatus 100 is stored in the storage unit 203 and the preset registration data is collectively instructed from a client device.

As the input unit 204, a button provided in hardware and devices such as a keyboard, a mouse, and a joystick can be used. The input unit 204 may be realized in a form of a touch panel in which a display unit (not illustrated) and the input unit 204 are integrated together.

The program memory 205 is a memory that stores a terminal control program, and the system control unit 201 executes various operations based on the terminal control program stored in the program memory 205.

As described above, the external apparatus 200 and a controller can perform command control on the image capturing apparatus 100 via the network 300.

### Preset Function

According to the present exemplary embodiment, a user can call a preset position associated with a preset number registered in advance by specifying the preset number and change an image capturing range.

A registration method of the preset position is described below. This function is referred to as a preset function. The preset function enables each driving unit (pan/tilt/lens driving unit) of the image capturing apparatus 100 to be driven to a specified preset position and to be moved by a shot operation (preset movement) in changing the image capturing range. Further, the preset function according to the present exemplary embodiment enables the image capturing apparatus 100 to specify an order of a plurality of preset positions and move between each preset position by the shot operation (preset tour). The preset function according to the present exemplary embodiment also enables the image capturing apparatus 100 to repeatedly move between each preset position in a predetermined order (automatic loop function).

The preset tour according to the present exemplary embodiment is described in detail below. In the preset tour according to the present exemplary embodiment, a user can set information about a speed in moving between the preset positions and information about an order of movement via the external apparatus 200. In other words, if a user instructs execution of the preset tour, the image capturing apparatus 100 according to the present exemplary embodiment can move between each preset position in the shot operation according to the information about the order and speed specified by the user.

A specific method for registering the preset position is described. The image capturing apparatus 100 according to the present exemplary embodiment respectively associates the positions of the lens driving unit 104, the pan driving unit 107, and the tilt driving unit 108 with the preset numbers to register the preset positions, but the present disclosure is not limited to this method. For example, the preset position may be registered by associating at least two of the positions of the lens driving unit 104, the pan driving unit 107, and the tilt driving unit 108 with the preset number. The preset position may be registered using a zoom value, a pan value, and a tilt value obtained by converting an optical lens position of the lens driving unit 104 and the positions of the pan driving unit 107 and the tilt driving unit 108. Further, the preset registration may be performed including an image quality setting in addition to the positions of the pan/tilt/lens driving units.

The user outputs information about the preset number together with an instruction to execute registration of the preset position (preset registration) to the image capturing apparatus 100 via the input unit 204 of the external apparatus 200.

If the image capturing apparatus 100 acquires the control command indicating the preset registration via the communication unit 114, the system control unit 101 acquires the current position of each driving unit from the pan-tilt control unit 109 and the zoom control unit 105, respectively.

Further, the system control unit 101 associates the acquired current position of each driving unit with the preset number and output them to the preset registration data 112. The preset registration data 112 stores the acquired current position and preset number of each driving unit.

The above-described preset registration processing (preset registration) is performed, so that the user can call the preset position associated with the preset number (preset movement). Further, the user can move the image capturing apparatus 100 between the registered preset positions in a predetermined order (preset tour) by specifying the order of a plurality of the preset numbers. Furthermore, the user instructs the image capturing apparatus 100 to repeat the preset movement in the predetermined order, so that the image capturing apparatus 100 can continuously travel between the preset positions in the predetermined order (automatic loop function).

### Shot Operation

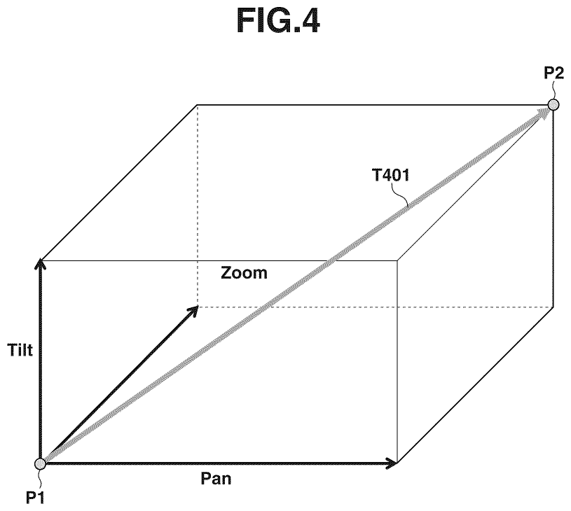

Processing for calculating the control speed of each driving unit in order to realize the shot operation in performing the preset tour is described. FIG. 4 is an image diagram in a case where each driving unit (pan/tilt/lens driving unit) of the image capturing apparatus 100 is driven by the shot operation. A horizontal axis, a vertical axis, and a depth axis respectively indicate the pan position, the tilt position, and the zoom position, respectively. The current position (preset position A) of each driving unit is indicated by P1, and the target position (preset position B) of each driving unit is indicated by P2. An arrow T401 indicates transition of each driving unit in the shot operation in the preset function and the automatic loop function, and each driving unit starts driving at the same time and stops driving at the same time.

Processing for calculating the control speed in a case where each of the above-described driving units (pan/tilt/lens driving units) performs the shot operation so as to start and stop driving at the same time in moving between the predetermined preset positions (preset tour) is described.

The system control unit 101 calculates a pan control speed V_{P}, a tilt control speed V_{T}, and a lens control speed V_{L} based on a driving time T specified by the user. According to the present exemplary embodiment, the user specifies the driving time T, but the present disclosure is not limited to this example. For example, the user may specify a parameter related to the speed. In other words, each control speed may be calculated based on an upper limit speed, a lower limit speed, and a speed table in a case where each driving unit is controlled at a predetermined speed. In that case, the pan control speed V_{P}, the tilt control speed V_{T}, and the lens control speed V_{L} are calculated so that a pan driving time T_{P} in which the pan driving unit 107 drives, a tilt driving time Tₜ in which the tilt driving unit 108 drives, and a lens driving time T_{L} in which the lens driving unit 104 drives match each other.

The driving time T set by the user is transmitted to the communication unit 114 via the network 300. The information about the order of the preset positions set by the user is transmitted to the communication unit 114 via the network 300. At this time, the information about the driving time T and the order of travelling the preset positions (preset tour) are transmitted in advance. In this case, data regarding the driving time T and the order of travelling the preset positions are stored as the information about the preset tour in the preset registration data 112 via the communication unit 114, but the present disclosure is not limited to this example. For example, the system control unit 101 may acquire the control command indicating execution of the preset tour together with the data regarding the driving time T and the order of travelling the preset positions.

The image capturing apparatus 100 may perform calculation processing for each control speed at a time when acquiring a setting of the preset tour from the user. The processing for calculating the control speed when the image capturing apparatus 100 moves from the preset position A to the preset position B at a speed based on the driving time T is described.

The system control unit 101 acquires the preset position of each driving unit and the driving time T in moving between the preset positions. In other words, the system control unit 101 acquires the preset positions A and B of the pan driving unit 107, the preset positions A and B of the tilt driving unit 108, and the preset positions A and B of the lens driving unit 104. Further, the system control unit 101 acquires the driving time T for driving from the preset position A to the preset position B from the external apparatus 200.

The system control unit 101 calculates a pan driving angle D_{P}, a tilt driving angle D_{T}, and a lens driving distance D_{L} based on the acquired preset positions A and B of each driving unit. For example, in a case where the preset position A of the pan driving unit 107 is 10 degrees, and the preset position B is 150 degrees, the pan driving angle D_{P} is calculated as follows:

$$150 - 10 = 140 degrees .$$

Similarly, the tilt driving angle D_{T} of the tilt driving unit 108 is calculated.

The lens driving distance D_{L} of the lens driving unit 104 is calculated. According to the present exemplary embodiment, the lens driving distance D_{L} (M) indicates a distance (M) in a case where a reference lens is driven from a current position to a target position inside a lens barrel, but the present disclosure is not limited to this example. Any value can be used as long as the control speed for driving from the preset position A to the preset position B can be calculated. For example, a zoom value indicating a zoom magnification is converted into a lens position, and the control speed may be calculated from the zoom value.

The pan control speed V_{P}, the tilt control speed V_{T}, and the lens control speed V_{L} are calculated from the calculated pan driving angle D_{P}, tilt driving angle D_{T}, lens driving distance D_{L}, and driving time T.

$$v = \frac{D}{T} \qquad ( 1 )$$

The system control unit 101 outputs the calculated pan control speed V_{P}, tilt control speed V_{T}, and lens control speed V_{L} to the preset registration data 112 and terminates the present processing. In a case where the preset tour is executed from the preset position A to the preset position B, the system control unit 101 performs control based on the pan control speed V_{P}, the tilt control speed V_{T}, and the lens control speed V_{L} (control information), which are calculated (determined) by the present processing, and thus the preset tour is performed by the shot operation.

### Correction Data Creation Method

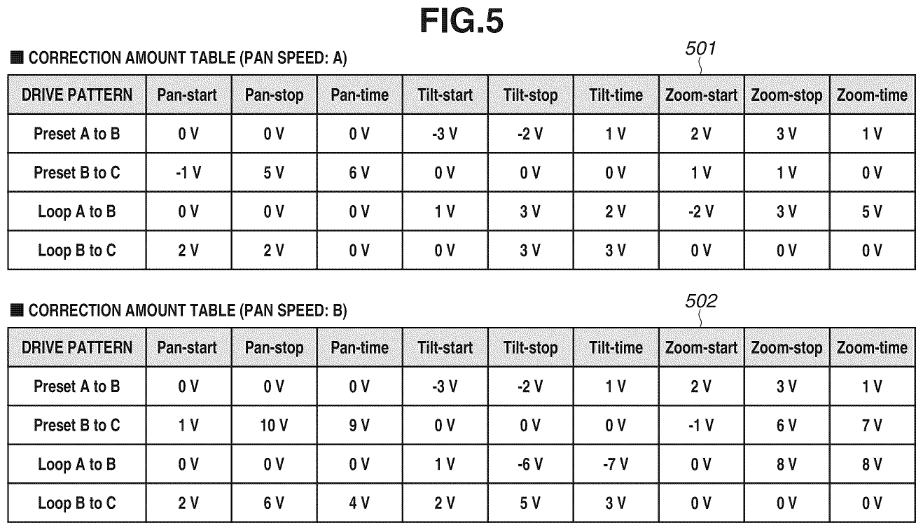

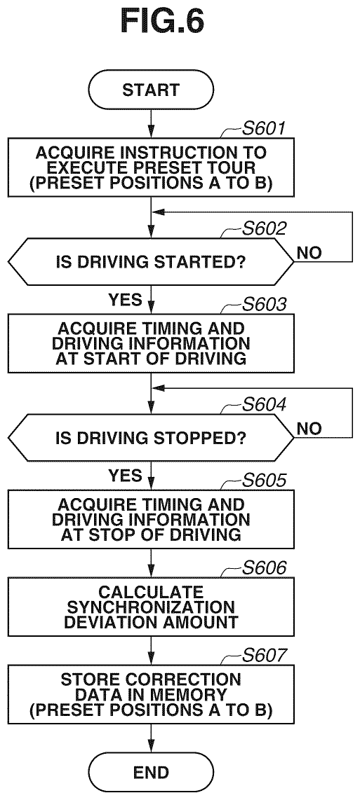

A method for creating correction data in moving from the preset position A to the preset position B according to the present exemplary embodiment is described with reference to FIG. 5 and a flowchart in FIG. 6.

FIG. 5 is an image diagram in which PTZ synchronization deviation amounts in performing the preset tour are stored and tabulated as correction amounts. The PTZ synchronization deviation amounts refer to errors in drive start and drive stop timings of the lens driving unit 104, the pan driving unit 107, and the tilt driving unit 108, and are hereinbelow referred to as synchronization deviation. The image capturing apparatus 100 according to the present exemplary embodiment uses the preset tour function and the automatic loop function to repeatedly move between the plurality of preset positions registered in advance. In the preset tour function and the automatic loop function, the synchronization deviation that is not noticeable with a single preset movement becomes noticeable if it accumulates.

In the present exemplary embodiment according to the present disclosure, in a case where the shot operation is performed at a predetermined speed between the predetermined preset positions, in other words, the preset tour and automatic loop functions are executed, the PTZ synchronization deviation amount is acquired and stored in the correction data calculation unit 113 as correction information. In a case where the shot operation is performed at the predetermined speed between the same preset positions, the control speed and the control timing are corrected based on the stored correction information. In other words, in a case where the correction information is stored in the correction data calculation unit 113, the control information such as the control speed and the control timing for realizing the shot operation are corrected based on the correction information. Regarding the correction information to be stored, a correction table is stored for each control speed of a reference driving unit among the control speeds calculated in performing the shot operation as indicated in correction amount tables 501 and 502 in FIG. 5, and further a combination correction table is created for each preset position. According to the present exemplary embodiment, the correction table is created for each speed of the pan driving unit 107 as the reference driving unit, but the reference driving unit may be either the tilt driving unit 108 or the lens driving unit 104. A first row in the correction amount table 501 lists, as correction data (correction information), deviation amounts in drive start, drive stop, and driving time of each of the lens driving unit 104, the pan driving unit 107, and the tilt driving unit 108 if driving is performed from the preset position A to the preset position B. In this example, the pan driving unit 107 is used as a reference axis, and the number of frames (unit: V) of correction required compared with the pan axis is calculated and stored. The correction amount may be stored as time information such as milliseconds instead of the number of frames. According to the present exemplary embodiment, the correction data is calculated based on the pan axis, but the information of which driving unit is used as the reference is not limited to this example. If the corresponding correction data is stored, the correction amount table for each speed may be calculated by interpolation. In a case where the correction data has been already created at a time of storing the corresponding correction data, the correction data may be overwritten, or an average value may be calculated and stored.

In a case where registered preset information is changed, the corresponding correction data is deleted.

In this way, in a case where the shot operation is performed at the predetermined speed between the predetermined preset positions such as the preset tour and the automatic loop, the correction data at that time is created. Further, in a case where the shot operation is performed to move between the same preset positions at the predetermined speed, the PTZ synchronization deviation can be suppressed by calculating the control command using the correction data.

A flowchart for creating the correction data for the PTZ synchronization control according to the present exemplary embodiment is described with reference to FIG. 6.

In the present flowchart, an operation system (OS), various programs, and various data are loaded into a random access memory (RAM, storage device) that temporarily stores a computer program executed by the system control unit 101, and the system control unit 101 executes the present processing. The processing in the flowchart in FIG. 6 is executed in a case where the system control unit 101 receives a control command indicating execution of the preset tour from the external apparatus 200 via a communication interface and performs the preset tour based on the control command.

In step S601, the system control unit 101 receives a control instruction indicating execution of the preset tour from the client apparatus (the external apparatus 200) via the communication unit 114 and acquires corresponding data from the preset registration data 112. The system control unit 101 calculates a driving speed necessary for the shot operation based on the acquired preset registration data and the driving time T in the preset tour specified by the user and issues an instruction to the zoom control unit 105, the pan driving unit 107, and the tilt driving unit 108.

In step S602, the system control unit 101 acquires driving information of the lens driving unit 104, the pan driving unit 107, and the tilt driving unit 108 until the lens driving unit 104, the pan driving unit 107, and the tilt driving unit 108 start driving from the preset position A. At this time, the driving information is periodically acquired, but the present disclosure is not limited to this example. If the driving information indicating that the lens driving unit 104, the pan driving unit 107, and the tilt driving unit 108 start driving from the preset position A is acquired (YES in step S602), the processing proceeds to step S603. Here, the driving information indicating that driving is started refers to information about the lens positions and respective motor positions of the lens driving unit 104, the pan driving unit 107, and the tilt driving unit 108, which are updated from the preset position A, and information in which flag information indicating a driving state controlled by each control unit indicates a driving state.

In step S603, the system control unit 101 acquires a timing (time information) at which the lens driving unit 104, the pan driving unit 107, and the tilt driving unit 108 start driving from the preset position A.

According to the present exemplary embodiment, the timing may be information about a time based on the time when the lens driving unit 104, the pan driving unit 107, or the tilt driving unit 108 first starts driving or when the flag information changes. Information about the time set in an apparatus main body may be used. Further, the system control unit 101 acquires the timing (time information) at which each driving unit starts driving from the preset position A and then outputs the driving information and the time information to the correction data calculation unit 113, and the processing proceeds to step S604.

In step S604, the system control unit 101 acquires the driving information of the lens driving unit 104, the pan driving unit 107, and the tilt driving unit 108 until the lens driving unit 104, the pan driving unit 107, and the tilt driving unit 108 stop driving. At this time, the driving information is periodically acquired, but the present disclosure is not limited to this example. If the driving information indicating that the lens driving unit 104, the pan driving unit 107, and the tilt driving unit 108 stop driving is acquired (YES in step S604), the processing proceeds to step S605. The driving information indicating that driving is stopped refers to information about the lens positions and respective motor positions of the lens driving unit 104, the pan driving unit 107, and the tilt driving unit 108, which are no longer updated, and information in which the flag information indicating the driving state controlled by each control unit indicates a stopped state. At this time, a fact that the lens position or the motor position remains at the same position for a predetermined period of time may be regarded as information indicating that the driving is stopped. If the driving information indicating that the lens driving unit 104, the pan driving unit 107, and the tilt driving unit 108 are stopped is acquired (YES in step S604), the processing proceeds to step S605.

In step S605, the system control unit 101 acquires a timing (time information) at which the lens driving unit 104, the pan driving unit 107, and the tilt driving unit 108 are stopped. Further, the system control unit 101 acquires the timing (time information) at which the lens driving unit 104, the pan driving unit 107, and the tilt driving unit 108 are stopped and then outputs the driving information and the time information to the correction data calculation unit 113, and the processing proceeds to step S606.

In step S606, the system control unit 101 calculates the PTZ synchronization deviation amount from the information (timing and driving information) at the time of starting driving, which is acquired in step S603, and the information (timing and driving information) at the time of stopping driving, which is acquired in step S605. An axis closest to the speed calculated based on the driving time specified by the user from the difference between the drive stop timing and the drive start timing of each of PTZ is set as the reference axis. Further, the number of frames by which the drive start timing, the drive stop timing, and the driving time are deviated from the reference axis is calculated as correction data.

In step S607, the system control unit 101 stores the synchronization deviation amount calculated in step S606 in a table for each corresponding preset and speed in the correction data calculation unit 113 and terminates the processing in the present flowchart.

### Correction Method

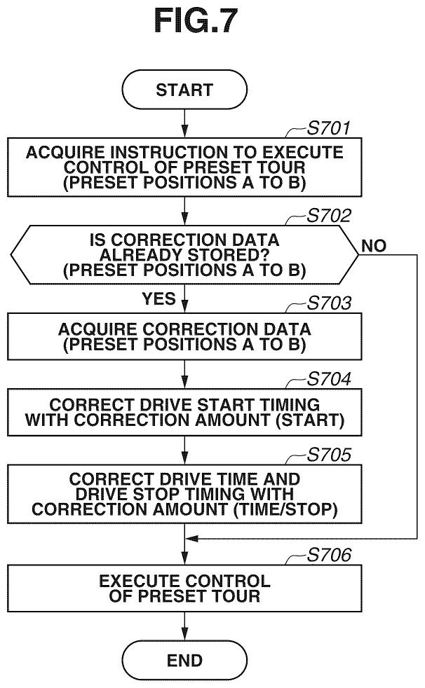

A flowchart for correcting the synchronization deviation according to the present exemplary embodiment is described with reference to FIG. 7.

In the present flowchart, the OS, various programs, and various data are loaded into the RAM (storage device) that temporarily stores a computer program executed by the system control unit 101, and the system control unit 101 executes the present processing. The processing in the flowchart in FIG. 7 is executed in a case where the system control unit 101 receives a control command indicating execution of the preset tour from the external apparatus 200 via the communication interface and performs the preset tour based on the control command.

In step S701, the system control unit 101 receives a preset control instruction from the client apparatus (the external apparatus 200) via the communication unit 114 and acquires corresponding data from the preset registration data 112.

In step S702, the system control unit 101 checks whether the corresponding correction data is stored in the correction data calculation unit 113. If there is no synchronization deviation correction data (NO in step S702), the processing proceeds to step S706 in which the shot operation is started without correction, and the present flowchart is terminated. Thereafter, the synchronization deviation correction data is stored according to the flowchart in FIG. 6. If there is the synchronization deviation correction data (YES in step S702), the processing proceeds to step S703.

In step S703, the system control unit 101 acquires the corresponding correction data from the correction data calculation unit 113.

In step S704, the system control unit 101 corrects the timing at which the system control unit 101 issues an instruction to the zoom control unit 105 and the pan-tilt control unit 109 based on the correction amount (START) for each of PTZ among the acquired correction data. According to the present exemplary embodiment, the timing of issuing an instruction is corrected, but the present disclosure is not limited to this example, and it is sufficient to correct the drive start timing or the drive stop timing. For example, the control command may be corrected to correct the time at which driving is started.

In step S705, the system control unit 101 applies the correction amount to the driving time of the shot operation based on the correction amount (TIME/STOP) for each of PTZ among the acquired correction data. In other words, the system control unit 101 corrects the information (control speed) for instructing the zoom control unit 105 and the pan-tilt control unit 109.

In step S706, the system control unit 101 outputs the control instruction to the zoom control unit 105 and the pan-tilt control unit 109 based on the control information and the control timing to which the correction data is applied, and then terminates the processing in the flowchart.

As described above, if the image capturing apparatus 100 performs control to move between the positions registered as preset positions in advance by the shot operation, the image capturing apparatus 100 records a timing of change in each driving information and corrects the synchronization deviation based on the recorded change information at the time of the next preset tour.

Accordingly, the image capturing apparatus 100 can suppress the deviation in the shot operation in moving between the predetermined preset positions.

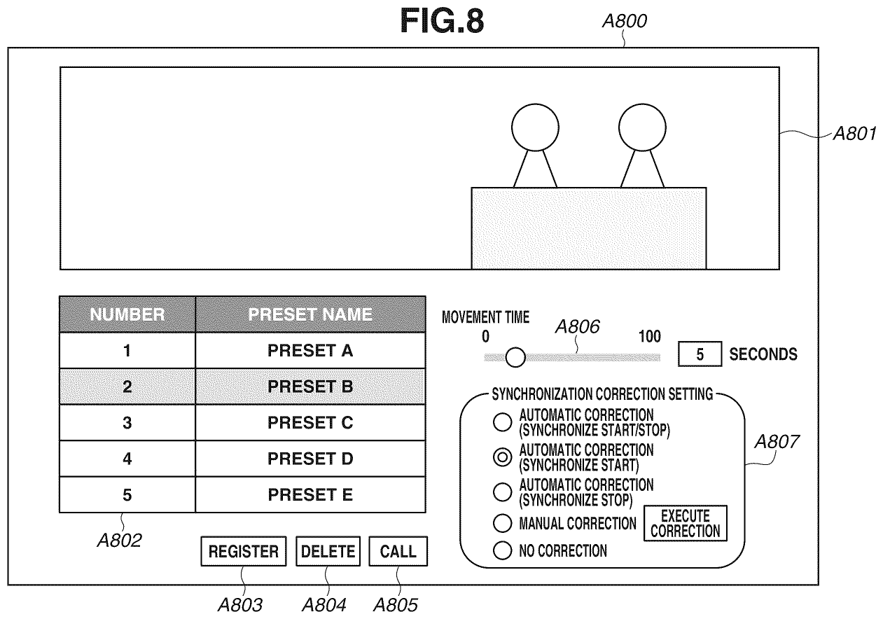

FIG. 8 illustrates an example of an application screen according to a second exemplary embodiment of the present disclosure that enables a user to set PTZ synchronization deviation correction control at the time of the shot operation in the preset function in relation to the control described in the first exemplary embodiment. A configuration diagram is similar to that according to the first exemplary embodiment, and descriptions of overlapping contents are omitted.

An example of a screen A800 of a web application for preset settings includes a captured video A801 displayed on a screen of the external apparatus 200 and a list A802 for displaying and selecting preset setting items. If a preset registration button A803 is pressed, the current settings of each driving unit, such as position and image quality, are registered to the preset number selected in the list A802.

If a preset delete button A804 is pressed, the content of the preset number selected in the list A802 is deleted. If a preset call button A805 is pressed, the content of the preset number selected in the list A802 is called. By performing the calling operation, a preset control instruction is issued to the image capturing apparatus 100, and the flows described with reference to FIGS. 6 and 7 are executed. An option setting A806 for performing the shot operation of the preset function can set the time required to reach the target position and include it in information about the preset control instruction issued to the image capturing apparatus 100. The setting of the option setting A806 is an example, and a parameter that sets the speed (control speed parameter) other than time may also be used. Setting items A807 are used to select a correction item from a user interface (UI) for the correction described in the first exemplary embodiment.

The setting items are examples, and there are three settings for automatic correction inside the image capturing apparatus 100: automatic correction of both drive start (START) and drive stop (STOP), automatic correction of only drive start (START), and automatic correction of only drive stop (STOP) for the synchronization correction control. There may be a setting for manual correction and a setting for no correction instead of automatic correction. If a correction execution button is pressed in a state where the manual correction is selected, preset driving is performed only once, and an operation for updating the data stored in the correction data calculation unit 113 is performed. As a method for setting the manual correction, a UI may be prepared for a user to directly input correction data for each driving unit. The setting items A807 are set, and then the preset call button A805 is pressed, so that the flows described with reference to FIGS. 6 and 7 can be partially executed.

Accordingly, a user can determine whether to correct the deviation in the shot operation in moving between the predetermined preset positions, and thus it is possible to suppress the deviation in the shot operation only in an appropriate portion.

While the present disclosure has been described with reference to exemplary embodiments, it is to be understood that the present disclosure is not limited to the exemplary embodiments, and various modifications and changes can be made within the scope of the appended claims.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-076480, filed May 9, 2024, which is hereby incorporated by reference herein in its entirety.

What is claimed is:

1. A control apparatus that controls an image capturing unit that drives a pan driving unit, a tilt driving unit and a lens driving unit to move between a plurality of preset positions that specify an image capturing range and the plurality of preset positions, the control apparatus comprising:
at least one memory storing instructions; and
at least one processor that, upon execution of the instructions, is configured to operate as:
a control unit that determines control information that controls the pan driving unit, the tilt driving unit, and the lens driving unit to start driving and stop driving simultaneously at a time of moving from a first preset position to a second preset position; and
an acquisition unit that acquires driving information of the pan driving unit, the tilt driving unit, and the lens driving unit at the time of moving from the first preset position to the second preset position,
wherein the driving information is information about a driving state of each of the pan driving unit, the tilt driving unit, and the lens driving unit, and
wherein, when acquiring the driving information at the time of moving from the first preset position to the second preset position, the control unit corrects the control information based on the driving information and controls the image capturing unit based on the corrected control information.

2. The control apparatus according to claim 1, wherein the driving information is information about a time when each of the pan driving unit, the tilt driving unit, and the lens driving unit starts or stops driving or a driving time when each of the pan driving unit, the tilt driving unit, and the lens driving unit is driven.

3. The control apparatus according to claim 1, wherein, in a case where the driving information is not acquired, the control unit does not correct the control information but controls the image capturing unit based on the control information that is not corrected.

4. The control apparatus according to claim 1, wherein the control unit calculates the control information based on a driving time set by a user.

5. The control apparatus according to claim 1, wherein the control information includes information about a speed at which each of the pan driving unit, the tilt driving unit, and the lens driving unit moves from the first preset position to the second preset position.

6. The control apparatus according to claim 1, wherein the control information includes information about a timing at which each of the pan driving unit, the tilt driving unit, and the lens driving unit starts moving from the first preset position to the second preset position.

7. The control apparatus according to claim 1, wherein the image capturing unit moves between the plurality of preset positions based on a setting regarding an order of the preset positions set by a user.

8. The control apparatus according to claim 1, wherein the control unit corrects the control information about a timing of starting movement from the first preset position to the second preset position based on the driving information.

9. The control apparatus according to claim 1, wherein the control unit corrects the control information about a speed of moving from the first preset position to the second preset position based on the driving information.

10. The control apparatus according to claim 1, wherein, at a time of moving from the first preset position to the second preset position, the control unit corrects the control information based on the driving information so that at least one of drive start timings and drive stop timings of the pan driving unit, the tilt driving unit, and the lens driving unit of an image capturing apparatus is simultaneous.

11. The control apparatus according to claim 2,
wherein, in a case where a position of a driving unit that is periodically acquired remains same for a predetermined period, it is determined that driving is stopped, and
wherein, in a case where the position of the driving unit changes after it is determined that driving is stopped, it is determined that driving is started.

12. The control apparatus according to claim 2, wherein the driving time is determined based on a time from when the driving is started to when the driving is stopped.

13. A method for controlling a control apparatus that controls an image capturing unit that drives a pan driving unit, a tilt driving unit, and a lens driving unit to move between a plurality of preset positions that specify an image capturing range and the plurality of preset positions, the method comprising:
determining control information that controls the pan driving unit, the tilt driving unit, and the lens driving unit to start driving and stop driving simultaneously at a time of moving from a first preset position to a second preset position; and
acquiring driving information of the pan driving unit, the tilt driving unit, and the lens driving unit at the time of moving from the first preset position to the second preset position,
wherein the driving information is information about a driving state of each of the pan driving unit, the tilt driving unit, and the lens driving unit, and
wherein, when acquiring the driving information at the time of moving from the first preset position to the second preset position, in the controlling, the control information is corrected based on the driving information, and the image capturing unit is controlled based on the corrected control information.

14. A non-transitory storage medium storing a program for causing a computer to function as a control apparatus that determines control information that controls a pan driving unit, a tilt driving unit, and a lens driving unit to start driving and stop driving simultaneously at a time of moving from a first preset position to a second preset position, the control apparatus comprising:
at least one memory storing instructions; and
at least one processor that, upon execution of the instructions, is configured to operate as:
a control unit that determines control information that controls the pan driving unit, the tilt driving unit, and the lens driving unit to start driving and stop driving simultaneously at a time of moving from a first preset position to a second preset position; and
an acquisition unit that acquires driving information of the pan driving unit, the tilt driving unit, and the lens driving unit at the time of moving from the first preset position to the second preset position,
wherein the driving information is information about a driving state of each of the pan driving unit, the tilt driving unit, and the lens driving unit, and
wherein, when acquiring the driving information at the time of moving from the first preset position to the second preset position, the control unit corrects the control information based on the driving information and controls the image capturing unit based on the corrected control information.
